(19) United States
(12) Patent Application Publication
(10) Pub. No.: US 2015/0048224 A1
(43) Pub. Date: Feb. 19, 2015

(54) SPRING TENSION DEVICE FOR SUPPORTING A TELEVISION

(71) Applicant: Emory Patterson, Natick, MA (US)

(72) Inventor: Emory Patterson, Natick, MA (US)

(21) Appl. No.: 14/460,957

(22) Filed: Aug. 15, 2014

Related U.S. Application Data
(60) Provisional application No. 61/866,105, filed on Aug. 15, 2013.

(51) Int. Cl. A47B 97/00; F16M 11/28; F16M 11/04

(52) U.S. Cl. CPC A47B 97/00; F16M 11/046; F16M 11/28; A47B 2097/005
USPC 248/200.1; 248/218.4

(57) ABSTRACT

A device for supporting a television includes a compressible, adjustable length pole on which is slidably mounted a bracket. The pole includes first and second elongated members that are joined in a telescoping relationship. A pair of springs resiliently urges the first and second members apart and thereby enables the pole to be easily and reliably installed in a vertical orientation between the floor and ceiling of a room. The mounting bracket includes a flat plate to which the television is coupled and a pair of arms, the distal end of each arm being dimensioned for fitted insertion into a corresponding longitudinal side channel formed in the pole. As such, the mounting bracket is designed to be linearly displaced along the length of the pole and subsequently locked in place relative thereto. In this manner, the viewing height of a television mounted on the bracket can be adjusted.

### FIELD OF THE INVENTION

The present invention relates generally to electronics accessories and more particularly to mounting structures for supporting televisions, monitors and the like.

### BACKGROUND OF THE INVENTION

Flat-panel televisions are well known in the art. Due to their relatively light weight, large screen size and increased level of affordability, flat-panel televisions have gained considerable commercial prominence in the electronics industry.

Flat-panel televisions are commonly displayed for viewing using different types of mounting structures.

As a first example, flat-panel televisions are often disposed on floor-mounted television stands. A floor-mounted television stand is commonly constructed as an enlarged, cabinet-like structure, or frame, that includes one or more shelves for receiving electronic components and an enlarged, flattened top surface which is adapted to directly support the flat-panel television.

As a second example, flat-panel televisions are often retained on wall-mounted brackets, or mounts. A wall-mounted bracket is permanently installed on a wall at a suitable location within the immediate viewing environment. The bracket typically includes a thin metal plate or other similar mounting component that is fixedly secured to the rear of a flat-panel television using one or more appropriate fastening elements, the plate often capable of a slight degree of pivoting, or swivel, to allow for small adjustments to the display angle of the television.

Although well-known and widely used in the art, both styles of television mounting structures detailed above have been found to suffer from a number of notable drawbacks.

As a first drawback, floor-mounted television stands are typically substantial in size and are found to be aesthetically unappealing. As a result, floor-mounted television stands often detract from the overall stylistic aspects of a flat-panel television mounted thereon.

As a second drawback, wall-mounted brackets are commonly disfavored due to the rather complex, labor-intensive and time-consuming installation process, which typically involves drilling a sizable hole in the wall and, in turn, directly securing the bracket to a vertical member, or stud, in the wall frame. Furthermore, it has been found that certain consumers are hesitant to engage in the aforementioned installation process due to the resultant damage that is created in the wall surface. For tenants who anticipate living in a residence for a shortened period of time (e.g., college students), the complexity of the installation process as well as the permanent damage created in the wall surface serve as major deterrents in utilizing wall-mounted brackets.

As a third drawback, both styles of television mounting structures offer limited, if any, vertical adjustability (i.e. the height off the floor) of the television to accommodate for differences in the number and/or location of viewers within the environment. For instance, a limited number of viewers who are located closer to the television would typically prefer a lower vertical position of the television, whereas a larger number of viewers, many of whom may be dispersed throughout the viewing environment, would typically prefer a higher, or elevated, vertical position of the television to accommodate all viewers.

### SUMMARY OF THE INVENTION

It is an object of the present invention to provide a new and improved device for supporting a flat-panel television, monitor or the like.

It is another object of the present invention to provide a device as described above that is limited in size, is aesthetically appealing and does not detract from the stylistic components of the television that it supports.

It is yet another object of the present invention to provide a device as described above that is easy to install and that does not cause permanent damage to the wall, floor or ceiling of a room.

It is still another object of the present invention to provide a device as described above that readily permits vertical adjustability of a flat-panel television supported thereby.

It is yet still another object of the present invention to provide a device as described above that has a limited number of parts, is inexpensive to manufacture and is simple to use.

Accordingly, as a feature of the present invention, there is provided a device for supporting a television, the device comprising (a) an adjustable length pole, and (b) a mounting bracket coupled to the pole.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIGS. 1(a)-(c) are front, rear and left side views of a first embodiment of a device for supporting a flat-panel television, monitor or the like, the device being constructed according to the teachings of the present invention, wherein selected hidden components in FIG. 1(a) are represented in dashed form for ease of illustration;

FIG. 2 is a partially exploded top view of the device shown in FIG. 1(a), taken along lines 2-2;

FIG. 3 is an enlarged, fragmentary, front view of the device shown in FIG. 1(a);

FIG. 4 is a left side view of the locking clasp shown in FIG. 3;

FIG. 5 is a fragmentary, top, rear perspective view of a second embodiment of a device for supporting a flat-panel television, monitor or the like, the device being constructed according to the teachings of the present invention; and

FIG. 6 is a section view of the device shown in FIG. 5, taken along lines 6-6.

### DETAILED DESCRIPTION OF THE INVENTION

### Construction of Television Support Device 11

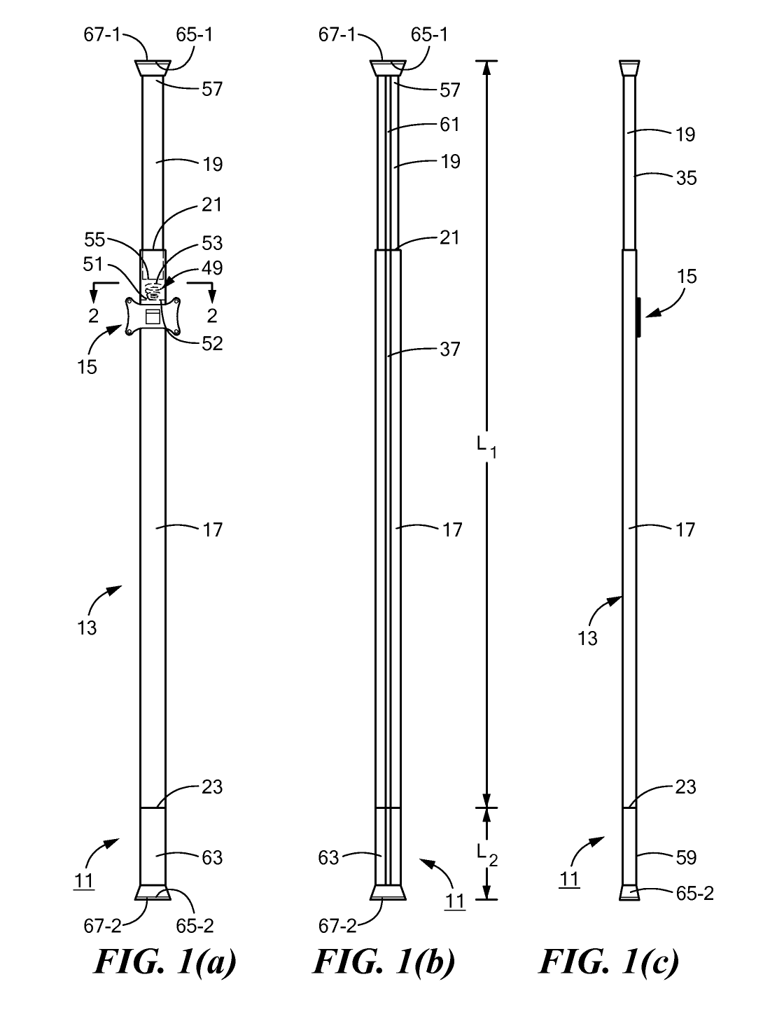

Referring now to FIGS. 1(a)-(c), there are shown front, rear, and left side views, respectively, of a first embodiment of a device for supporting a flat-panel television, the device being constructed according to the teachings of the present invention and identified generally by reference numeral 11. As will be described in detail below, device 11 is designed, inter alia, (i) to be easy installed without permanently damaging or otherwise marring the ceiling, walls or floor of a room, and (ii) to allow for vertical adjustability of the television supported thereby to suit the needs of the viewing audience, which are both principal objects of the present invention.

For simplicity purposes only, device 11 is described herein for use in supporting a flat-panel television. However, it should be noted that device 11 is not limited for use with flat-panel televisions. Rather, it is to be understood that device 11 could be utilized to support other types of similarly sized electronic items, such as flat-panel displays and monitors, without departing from the spirit of the present invention.

As can be seen, device 11 comprises a compressible, outwardly spring-biased, adjustable length pole 13 and a mounting bracket 15 that is coupled to pole 13. As will be described further in detail below, mounting bracket 15 is adapted to be vertically displaced along the length of pole 13 and locked in position relative thereto.

Pole 13 comprises a first elongated member 17 and a second elongated member 19 that are connected in a telescoping relationship to form a unitary vertical column. As will be described further below, pole 13 is designed to extend vertically between the floor and ceiling of a room, the outward spring-biased relationship between first and second members 17 and 19 serving to fixedly and securely retain pole 13 in place.

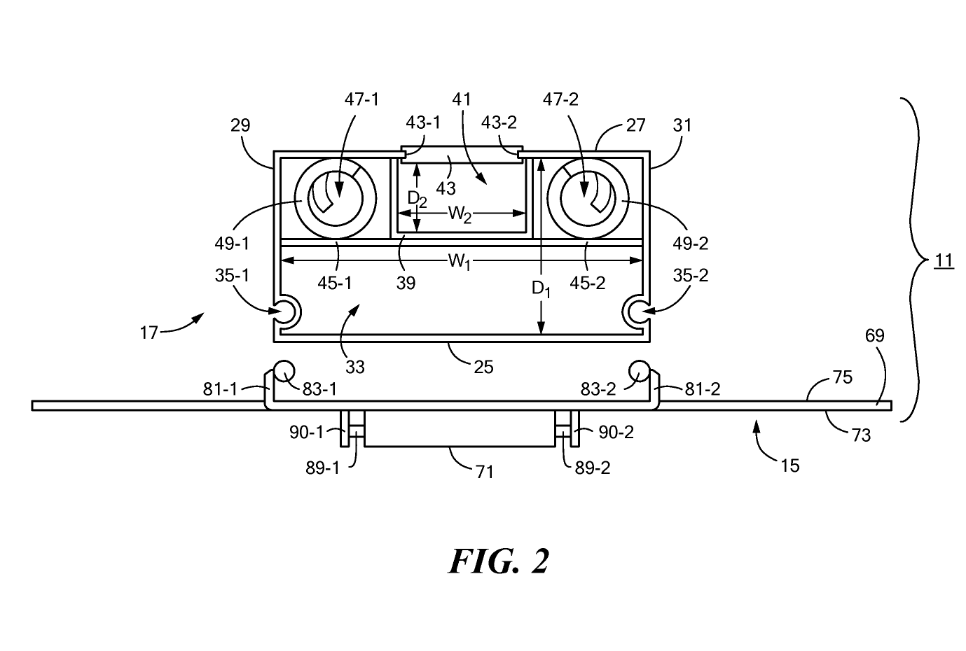

First elongated member, or outer rail, 17 is constructed of a rigid and durable material, such as plastic or metal, and includes an open first end 21 and an open second end 23. As seen most clearly in FIG. 2, first member 17 has a generally rectangular shape in transverse cross-section along the majority of its length, with a width W₁ of approximately 3 inches and a depth D₁ of approximately 1.5 inches.

First member 17 includes opposing, flat, front and rear walls 25 and 27, respectively, and opposing, flat, outer side walls 29 and 31, respectively, that together define an interior cavity 33. A pair of longitudinal channels 35-1 and 35-2 is formed into outer side walls 29 and 31, respectively, and extends the length of first member 17. Each channel 35 is generally semicircular in transverse cross-section and is dimensioned to fittingly receive a complementary member on mounting bracket 15, as will be described further in detail below.

First member 17 is additionally shaped to include a longitudinal slot 37 in rear wall 27 that extends the entirety of its length, as seen in FIG. 1(b). A three-sided, interior column 39, generally U-shaped in transverse cross-section, is disposed within interior cavity 33, as shown in FIG. 2, column 39 having a width W₂ of approximately 1 inch and a depth D₂ of approximately 0.75 inches. The free ends of column 39 are connected to the interior surface of rear wall 27 on opposite sides of slot 37. As such, column 39 defines a longitudinal cord-receiving channel 41 that extends the length of member 17, with slot 37 providing external access into channel 41.

Preferably, a plurality of plastic clips 43 is secured to rear wall 27 within slot 37 to partially enclose channel 41. As seen in FIG. 2, each clip 43 is preferably constructed as a flat rectangular tab with opposing, rounded notches 43-1 and 43-2 formed into its sides to allow for removable coupling of each clip 43 to rear wall 27.

A pair of internal partitions 45-1 and 45-2 extends laterally inward from outer sidewalls 29 and 31, respectively. Each partition 45 lies substantially coplanar with the lateral portion of column 39 and thereby defines a pair of vertical spring cavities 47-1 and 47-2 on opposite sides of column 39.

A pair of vertically disposed, linear compression springs 49-1 and 49-2 is disposed in cavities 47-1 and 47-2, respectively. As seen most clearly in FIG. 1(a), an inner end 51 of each spring 49 is fixedly secured to first member 17 (e.g., by an internal wall 53 disposed in interior cavity 33 at a location spaced in from first end 21) and an outer, or free, end 53 of each spring 49 extends upward out from a corresponding cavity 47.

Referring back to FIGS. 1(a)-(c), second elongated member, or inner rail, 19 is similar in design to first elongated member 17. Specifically, second elongated member 19 is similarly constructed of a rigid and durable material, such as plastic or metal, and includes an enclosed first end 55 and an open second end 57.

As can be seen, second member 19 has the same general rectangular shape in transverse cross-section along the majority of its length as first member 17. However, the dimensions of second member 19 in width and depth are just slightly less than the corresponding dimensions of first member 19. Accordingly, enclosed first end 55 of second member 19 is sized and shaped for fitted insertion into first end 21 of first member 17 to create a telescoping interconnection between components, as seen most clearly in FIG. 1(a).

It should be noted that enclosed first end 55 of second member 19 directly abuts against the free end 53 of springs 49. In this capacity, inner rail 19 is capable of further insertion into outer rail 17 upon applying a suitable compressive force thereto. However, once the compressive force is removed, the resilient nature of springs 49 urges inner rail 19 away from outer rail 17 to its original position. Based on this construction, it is to be understood that the combined, adjustable length L₁ of first and second members 17 and 19 preferably ranges between approximately 7.5 feet and 8.5 feet.

As seen in FIG. 1(c), second member 19 is also similar to first member 17 in that second member 19 is preferably shaped to includes a pair of opposing, longitudinal side channels 59 that preferably coaxially align with longitudinal channels 35 in first member 17, for reasons to become apparent below (only one side channel 59 being shown in the drawings for ease of illustration purposes only). Furthermore, as seen in FIG. 1(b), second member 19 is also similar to first member 17 in that second member 19 is preferably shaped to include a rear longitudinal slot 61 that extends in a co-linear fashion relative to slot 37, with slot 61 preferably enclosed, at select locations, using plastic clips 43, which are not shown in FIG. 1(b) for simplicity purposes.

An optional third member 63, or spacer, is secured to second end 23 of first member 17 in a coaxial relationship relative thereto, third member 63 preferably having the same cross-sectional dimensions as first member 17 to create a seamless, continuous construction along the length of pole 13. Preferably, optional third member 63 has a length L₂ of approximately 1 foot. Accordingly, the overall length of pole 13 (i.e., length L₁+L₂) ranges between 8.5 feet and 9.5 feet.

As can be appreciated, the inclusion, removal or replacement of spacer member 63 enables pole 13 to be used in rooms of varying ceiling heights. For instance, in a room with a 9 foot ceiling, it is envisioned that spacer member 63 provides pole 13 with the proper overall range of length (i.e., between 8.5 feet to 9.5 feet) so as to extend firmly between the ceiling and floor. In a room with an 8 foot ceiling, it is envisioned that spacer member 63 be removed from first member 17, thereby providing pole 13 with the proper overall range of length for use (i.e., between 7.5 feet to 8.5 feet). Furthermore, in a room with a 10 foot ceiling, it is envisioned that a replacement spacer member of 2 feet in length (not shown) be used in place of third member 63 to provide pole 13 with the proper overall range of length for use (i.e., between 9.5 feet and 10.5 feet). In this capacity, it is to be understood that the use, removal or replacement of optional third member 63 enables device 11 to be used in a wide variety of potential applications, which is highly desirable.

Referring back to FIGS. 1(a)-(c), a pair of caps 65-1 and 65-2 are mounted onto the free ends of pole 13. Specifically, an upper cap 65-1 is mounted onto open second end 57 of second member 19 and a lower cap 65-2 is mounted onto the free end of spacer member 63.

Each cap 65 is preferably constructed as an outwardly tapered, or pedestal-like, plastic insert that inserts partially into pole 13 in a fitted relationship relative thereto. Although not shown herein, a fastening element may be inserted through a bracket integrated into cap 65 as well as pole 13 to prevent inadvertent separation.

Planar pads 67-1 and 67-2 are preferably provided on the free end of caps 65-1 and 65-2, respectively. Preferably, each pad 67 is constructed of a highly frictional material, such as rubber, to prevent slippage of device 11 once installed.

As referenced briefly above, mounting bracket 15 is coupled to pole 13 and is capable of vertical displacement relative thereto. Mounting bracket 15 is designed to support a flat panel television and, as such, allows for vertical repositioning of the television along pole 13 to suit the needs of the viewing audience.

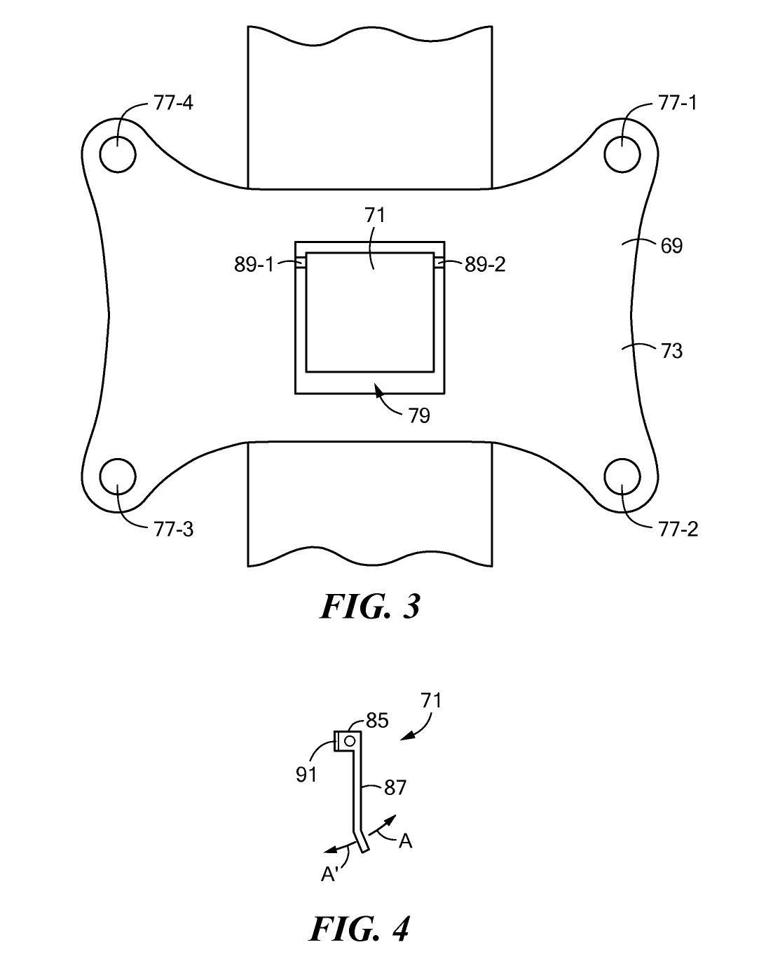

Referring now to FIGS. 2 and 3, bracket 15 includes a mounting plate 69 and a locking clasp 71 pivotally connected to plate 69. As will be described in detail below, locking clasp 71 is adapted to selectively engage pole 13 so as to lockably retain the vertical position of mounting plate 69 relative to pole 13.

Mounting plate 69 is preferably constructed as a unitary, generally bowtie-shaped plate that includes a flat front surface 73 and a flat rear surface 75, plate 69 being manufactured out of a rigid and durable material, such as an extruded aluminum. As seen most clearly in FIG. 3, plate 69 is shaped to include four, circular, transverse holes 77-1 thru 77-4 as well as a central, square-shaped transverse opening 79. It is to be understood that, with a universal television mounting bracket (not shown) mounted on front surface 73 of plate 69 and, in addition, disposed firmly against the rear of a flat-panel television (e.g., in a shallow cavity formed in the television housing), a fastening element (e.g., an elongated bolt) is preferably inserted through each hole 77, through a corresponding opening in the universal mounting bracket, and is retained with a complementary fastening element (e.g., a nut) to fixedly retain the television on mounting plate 69.

As seen most clearly in FIG. 2, a pair of arms 81-1 and 81-2 extend orthogonally outward from rear surface 75 of mounting plate 69. A pair of spherical members 83-1 and 83-2, respectively, is integrally formed onto the free ends of arms 81-1 and 81-2, respectively. As can be appreciated, spherical members 83-1 and 83-2 are dimensioned for fitted insertion into channels 35-1 and 35-2, respectively, in first member 17 (as well as in corresponding channels 59 formed in second member 19). In this manner, collinear channels 35 and 59 form a continuous, linear track in each side of pole 13 that receives an associated spherical members 83 and thereby limit displacement of mounting plate 69 relative to pole 13 along a linear vertical path.

As seen most clearly in FIGS. 2-4, locking clasp 71 is constructed as an elongated, L-shaped lever with an enlargement 85, which is generally rectangular in transverse cross-section, formed at one end and a generally flattened tab 87 formed at the opposite end.

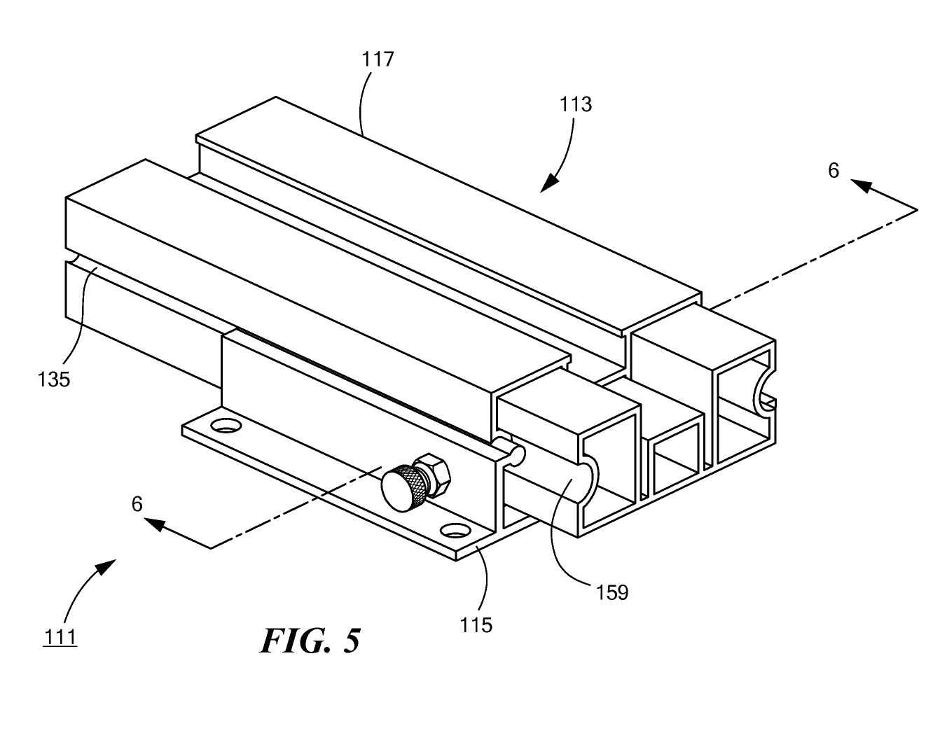

A pair of shortened cylindrical pins 89-1 and 89-3 extends outwardly from opposing sides of enlargement 85. With enlargement 85 of clasp 71 positioned within opening 79, pins 89 fittingly project into corresponding bores (not shown) formed into opposing flanges 90-1 and 90-2, respectively, that project forward from front surface 73 of mounting plate 69 about the periphery of opening 79. Accordingly, it is to be understood that clasp 71 is capable of pivoting about pins 89 along a bidirectional arcuate path, as represented by arrows A and A′ in FIG. 4.

A planar pad 91, which is preferably constructed of a durable, highly frictional material (e.g., rubber), is disposed on the rear surface of enlargement 85. With flattened tab 87 disposed in a generally vertical position (as shown in FIG. 4), the enlarged, exposed surface of planar pad 91 is disposed firmly against the front surface of pole 13, thereby locking plate 69 in position relative to pole 13. However, pivoting flattened tab 87 forward and upward towards a near horizontal position disengages rubber pad 91 from contact against pole 13 to the extent necessary that locking plate 69 is able to move vertically relative to pole 13.

### Installation and Use of Television Support Device 11

Support device 11 is designed to be installed and utilized in the following manner to display a flat-panel television within a room. Specifically, with the flat-panel television dismounted from support device 11 and the appropriate, if any, spacer member 63 attached to second end 23 of first member 17, the installer locates where in the room the device 11 is to be positioned. Once the mounting location is determined, the installer grasps first member 17, holds pole 13 at a slight angle, and disposes pad 67-1 of upper cap 65-1 flush against the ceiling at the desired location. While applying a suitable upward force onto first member 17 so as to compress, or collapse, pole 13, the installer then positions pad 67-2 of lower cap 65-2 against the floor directly beneath upper cap 65-1 (i.e., so that pole 13 extends vertically from the floor to the ceiling). Once the installer releases the compressive force, springs 49 cause pole 13 to resiliently expand, or extend, so that pads 67-1 and 67-2 firmly contact the ceiling and floor, respectively, of the room. Disposed as such, the continuous, significant expansion force applied by springs 49 onto members 17 and 19 serves to retain pole 13 firmly in its desired vertical orientation. If repositioning is required, the installer can, once again, apply an upward force onto first member 17 to the extent necessary to collapse pole 13 to a length that is less than the ceiling height in the room.

With pole 13 installed in the manner set forth above, the desired viewing height of the flat-panel television is determined and the location of the mounting plate 69 is adjusted accordingly. Specifically, locking clasp 71 is disposed in its unlocked position by pivoting tab 87 forward and upward, as represented by arrow A in FIG. 4, until rubber pad 91 substantially disengages from pole 13. Locking plate 69 is then displaced vertically along pole 13 to its desired height, with collinear channels 35 and 59 creating a continuous track that limits the travel of spherical members 83 along a linear vertical path. Once mounting plate 69 is disposed at its desired height, locking clasp 71 is locked by pivoting tab 87 downward, as represented by arrow A′ in FIG. 4, until rubber pad 91 firmly engages pole 13. Disposed as such, clasp 71 effectively locks the vertical position of plate 69 on pole 13.

Having properly installed support device 11, the flat-panel television is mounted onto plate 69 of bracket 15. As noted previously, a fastening element is preferably inserted through each hole 77 in plate 69 and into engagement with the television to fixedly retain the television on mounting plate 69. The electrical cord for the television preferably extends longitudinally within cord receiving channel 41 in pole 13 and is retained therein by clips 43. In this capacity, the electrical cord is effectively hidden within pole 13 for aesthetic purposes.

If readjustment of the vertical position of the television is subsequently required, the television is removed from plate 69, locking clasp 71 is unlocked, and mounting plate 69 is moved as desired. Once mounting plate 69 is disposed at its desired height, locking clasp 71 is locked and the television is mounted back onto plate 69.

### Features and Advantages of Support Device 11

As referenced above, television mounting device 11 provides a number of distinct advantages over traditional mounting structures for flat-panel televisions.

As a first advantage, television mounting device 11 is not only easy to install but also does not create permanent damage to either the ceiling, walls or floor of the room in which it installed, which is highly desirable. In fact, because the spring-biased construction of pole 13 allows for ease of installation, it is envisioned that mounting device 11 could be reinstalled repeatedly by someone who is prone to a change in residence (e.g., a college student). Furthermore, as a result of its unitary, compact and relatively lightweight design, device 11 is rendered highly portable in nature.

As a second advantage, the vertical adjustability of mounting bracket 15 relative to pole 13 enables the viewing height of a television mounted on plate 69 to be easily adjusted to accommodate different viewing conditions, which is highly desirable.

As a third advantage, television mounting device 11 is sleek and inconspicuous in its design and therefore does not detract from the stylistic attributes of a flat-panel television mounted thereon, which is highly desirable.

### Alternative Constructions and Design Variations

It is to be understood that the embodiment described in detail above is intended to be merely exemplary and those skilled in the art shall be able to make numerous variations and modifications without departing from the spirit of the present invention. All such variations and modifications are intended to be within the scope of the present invention as defined in the appended claims.

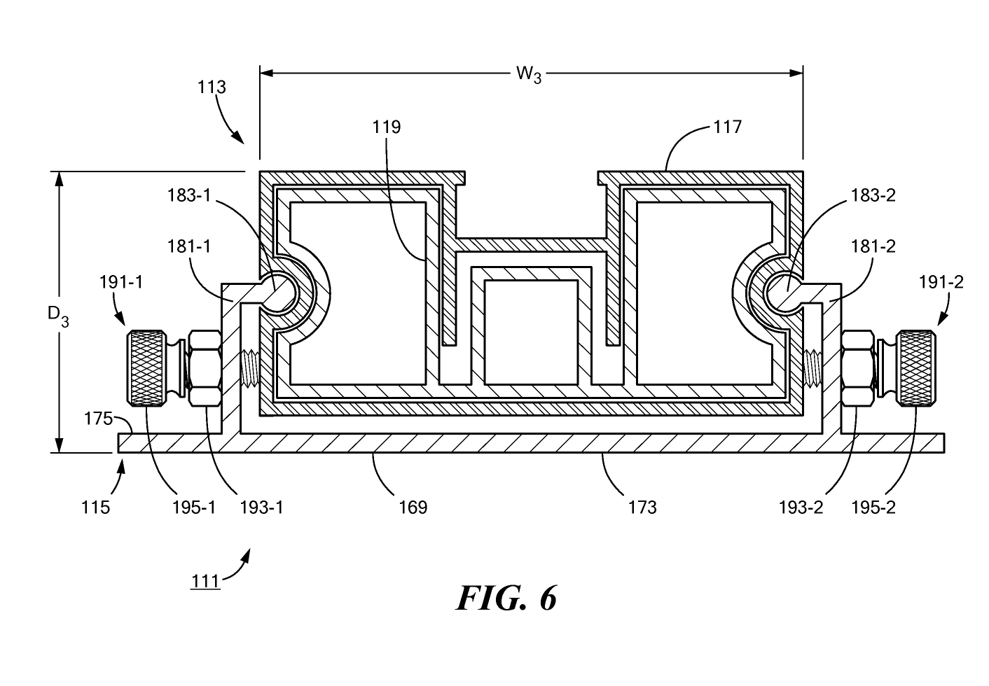

For instance, referring now to FIGS. 5 and 6, there is shown a second embodiment of a device for supporting a flat-panel television or the like, the device being constructed according to the teachings of the present invention and identified generally by reference numeral 111.

Device 111 is similar to device 11 in that device 111 comprises a compressible, outwardly spring-biased, adjustable length pole 113 and a mounting bracket 115 coupled thereto, with mounting bracket 115 adapted to be slidably displaced along the length of pole 113 along a vertical path and selectively locked in position relative thereto.

Pole 113 is similar in construction to pole 13 in that pole 113 comprises a first elongated member, or outer rail, 117 and a second elongated member, or inner rail, 119 that are connected in a telescoping relationship to form a unitary vertical column. Additionally, each of rails 117 and 119 is preferably constructed of a durable material, such as extruded aluminum, and is shaped to define opposing, longitudinal side channels 135 and 159, respectively, that extend in nested, coaxial alignment with one another.

Pole 113 differs slightly in the cross-sectional configuration of outer and inner rails 117 and 119. For instance, the overall cross-sectional footprint of pole 113 is slightly larger than pole 13, with pole 113 having a width W₃ of approximately 3.625 inches and a depth D₃ of approximately 1.625 inches.

Bracket 115 is similar to bracket 15 in that bracket 115 comprises a mounting plate 169, preferably constructed of a rigid and durable material such as an extruded aluminum, that includes a flat front surface 173 and a flat rear surface 175. Additionally, a pair of L-shaped arms 181-1 and 181-2 extends orthogonally outward from rear surface 175 of mounting plate 169, with a pair of inwardly directed spherical members 183-1 and 183-2 integrally formed onto the free ends of arms 181-1 and 181-2, respectively. In use, spherical members 183 function similarly to spherical members 83 in that spherical members 183 are dimensioned for fitted insertion in channels 135 and 159 and thereby limit the displacement of mounting plate 169 relative to pole 113 along a linear vertical path.

Bracket 115 differs from bracket 15 in the manner in which mounting plate 169 is fixed in place in relation to pole 113. Specifically, in place of locking clasp 71, bracket 115 includes a pair of opposing fastening elements 191-1 and 191-2 for securing the position of mounting plate 169 in relation to pole 113.

Fastening element 191-1 comprises an internally threaded hex nut 193-1 that is preferably permanently affixed to outer surface of arm 181-1, such as through a welding process. Similarly, fastening element 191-2 comprises an internally threaded hex nut 193-2 that is preferably permanently affixed to outer surface of arm 181-2, such as through a welding process. A lateral transverse bore (not shown) is preferably formed in each arm 181 in axial alignment with hex nut 193.

In turn, a pair of externally threaded, knurled thumb screws 195-1 and 195-2 is driven laterally inward through hex nuts 193-1 and 193-2, respectively, in threaded engagement therewith. Continued penetration of thumb screws 195 through corresponding hex nuts 193 ultimately results in the frictional engagement of each thumb screw 195 against pole 113 (i.e., into engagement with either outer rail 117 or inner rail 119 depending on the vertical location of mounting bracket 115).

Accordingly, by loosening (i.e., withdrawing) each thumb screw 195 in relation to its associated hex nut 193, mounting bracket 115 is free to slide vertically along the length of pole 113 to a desired height. Once the proper location of mounting bracket 115 is selected, sufficiently tightening (i.e., inserting) each thumb screw 195 in relation to its associate hex nut 193 locks mounting bracket 115 in place on pole 113.

1. A device for supporting a television, the device comprising:
(a) an adjustable length pole; and
(b) a mounting bracket coupled to the pole.

2. The device as claimed in claim 1 wherein the pole is compressible and outwardly spring-biased.

3. The device as claimed in claim 2 wherein the pole comprises:
(a) a first elongated member; and
(b) a second elongated member connected to the first elongated member in a telescoping relationship.

4. The device as claimed in claim 3 further comprising at least one spring coupled to the first and second elongated members, the at least one spring resiliently biasing the second elongated member away from the first elongated member.

5. The device as claimed in claim 4 wherein the pole further comprises a spacer member adapted to be releasably secured to one of the first and second elongated members.

6. The device as claimed in claim 1 wherein the mounting bracket is slidably coupled to the pole.

7. The device as claimed in claim 6 wherein the mounting bracket is adapted for vertical displacement along the pole and to be selectively locked in position relative thereto.

8. The device as claimed in claim 7 wherein the pole is shaped to define a longitudinal side channel.

9. The device as claimed in claim 8 wherein the mounting bracket comprises:
(a) a mounting plate with a flat front surface and a flat rear surface; and
(b) an arm extending out from the mounting plate, the arm having a free end that is dimensioned for fitted insertion into the longitudinal side channel in the pole, thereby limiting displacement of the mounting bracket relative to the pole along a linear vertical path.

10. The device as claimed in claim 9 wherein each of the longitudinal side channel and the free end of the arm is generally circular in transverse cross-section.

11. The device as claimed in claim 9 wherein the mounting bracket further comprises a locking clasp that is pivotally coupled to the mounting plate, the locking clasp being adapted to selectively frictionally engage the pole so as to lock the position of the mounting bracket in relation to the pole.

12. The device as claimed in claim 9 wherein the mounting bracket further comprises a fastening element coupled to the arm, the fastening element being adapted to selectively frictionally engage the pole so as to lock the position of the mounting bracket in relation to the pole.

13. The device as claimed in claim 12 wherein the fastening element includes an externally threaded thumb screw that is adapted to penetrate through the arm and selectively frictionally engage the pole so as to lock the position of the mounting bracket in relation to the pole.

14. The device as claimed in claim 7 wherein the pole is shaped to define an open, longitudinal, cord-receiving channel.

15. The device as claimed in claim 14 further comprising at least one clip adapted to be releasably secured to the pole so as to at least partially enclose the cord-receiving channel.
